(19) United States
(12) Patent Application Publication
(10) Pub. No.: US 2016/0143306 A1
(43) Pub. Date: May 26, 2016

(54) Bacterially Fermented, Dairy-Based, Semi-Solid Food Composition and Method for Making the Same

(71) Applicant: Rajiv Dhand, Knoxville, TN (US)

(72) Inventor: Rajiv Dhand, Knoxville, TN (US)

(21) Appl. No.: 14/886,702

(22) Filed: Oct. 19, 2015

Related U.S. Application Data
(60) Provisional application No. 62/082,977, filed on Nov. 21, 2014.

(51) Int. Cl. A23C 9/13

(52) U.S. Cl. CPC A23C 9/1307

(57) ABSTRACT

A food composition comprising spicy and savory ingredients in a bacterially fermented semi-solid dairy composition, commonly referred to as yogurt. In accordance with an exemplary embodiment, in addition to sweet or fruity ingredients, chutneys and spices in a variety of new flavor combinations are mixed with yogurt and made commercially available in a package to be mixed with the packaged yogurt.

### CROSS-REFERENCE TO RELATED APPLICATIONS

This application claims the benefit of U.S. Provisional Patent Application No. 62/082,977, filed on Nov. 21, 2014, which is incorporated herein in its entirety by reference.

### STATEMENT REGARDING FEDERALLY SPONSORED RESEARCH OR DEVELOPMENT

Not Applicable

### BACKGROUND OF THE INVENTION

1. Field of Invention

The invention relates to a food composition. More particularly, it relates to a combination of sweet and spicy ingredients in a bacterially fermented, dairy-based, semi-solid food composition commonly referred to, and referred to herein, as yogurt.

2. Description of the Related Art

In Western cultures, yogurt is typically consumed by itself either plain or mixed with various fruit and/or fruit flavors. When not consumed by itself, it is typically used in cooking as a marinade. Packaged flavors are often used for sweetening the yogurt. In the East and Middle East, yogurt is added to various foods, such as rice, or plain yogurt is eaten by itself or admixed with various vegetables. In addition, sweet and spicy mixtures with yogurt are served as snacks or appetizers. And, it is known to use yogurt and/or spices in various food compositions. For example, there are various recipes, such as a recipe for yogurt dressing that includes turmeric, coriander, cumin, ginger, and cayenne pepper. Additionally, U.S. Pat. No. 4,362,750 issued to Swartz on Dec. 7, 1982 discloses the use of yogurt in the production of a fermented sausage product. U.S. Pat. No. 6,403,144 issued to El-Khoury et al. on Jun. 11, 2002, discloses various food preparation compositions that include anti-sticking agents, flavor enhancing agents, and an anti-foam agent. U.S. Pat. No. 6,534,102 issued to Kazemzadeh on Mar. 18, 2003, discloses a shaker delivered savory or sweet seasoning, high protein stabilized crunchy matrix formed into various shapes. U.S. Pat. No. 6,777,017 issued to Porter et al. on Aug. 17, 2004 discloses a protein supplemented cooked dough product. U.S. Pat. No. 6,800,307 issued to Matthews et al. on Oct. 5, 2004, discloses a cooked sausage comprising a mixture of a meat emulsion and a fermented milk product and a method for cooking the same. U.S. Pat. No. 8,455,019 issued to Milo et al. on Jun. 4, 2013, discloses a food or beverage composition comprising unroasted coffee solids and arabinogalactans in a ready-to-drink beverage. U.S. Pat. No. 8,802,182 issued to Julien et al. on Aug. 12, 2014, discloses a bread-making improver consisting essentially of one or two water-soluble food ingredients and at least one enzyme. U.S. Pat. No. 8,815,956 issued to Tachdjian on Aug. 26, 2014, discloses a sweet flavor modifier useful in a variety of food compositions including fermented dairy compositions. U.S. Pat. No. 8,828,472 issued to Martinsen on Sep. 9, 2014, discloses food products containing Omega-3 fatty acids as well as a method of preparing those food products. U.S. Pat. No. 8,840,946 issued to Fleury Rey on Sep. 23, 2014, discloses a baked foodstuff with an improved flavor and an improved texture. U.S. Patent Appl'n No. 2012/0201945 by Iwahata et al., published on Aug. 9, 2012, discloses a means for reinforcing or enhancing the salty taste of sodium chloride in a food composition. And, finally, U.S. Patent Appl'n No. 2014/0242255 by Jia et al. published on Aug. 28, 2014, discloses sweetened consumables.

What is missing from the art is a commercially available blend of sweet, spicy, and savory ingredients mixed with yogurt. Accordingly, one of the objects of the present general inventive concept is to provide unique preparations of yogurt with a blend of Indian, Middle Eastern, and western condiments and spices along with a variety of sweet ingredients in a commercially available package. These preparations will be available commercially as individual packets with the ingredients pre-mixed or in separate packaging to be mixed at the time of consumption. Thus, these packages will be unique because they will provide novel ingredients in the sweet and spicy flavors which are available as a commercially marketed package that will include new mixtures of sweet and spicy flavors with a variety of yogurts. The novelty of my idea is in providing the chutneys and spices in a variety of new flavors and making them commercially available in a package mixed with yogurt.

### BRIEF SUMMARY OF THE INVENTION

The present general inventive concept relates to providing spicy and savory ingredients in a bacterially fermented semi-solid dairy composition, commonly referred to as yogurt, in addition to sweet or fruity ingredients, for instance in an exemplary embodiment, chutneys and spices in a variety of new flavor combinations are mixed with yogurt and made commercially available in a package to be mixed with the packaged yogurt.

### DETAILED DESCRIPTION OF THE INVENTION

As is understood by those skilled in the art, yogurt, especially in Western culture, if not served plain, is typically mixed with the following fruit flavors, banana, pineapple, peach, strawberry, raspberry, blueberry, cherry, apple, mango, blackberry, vanilla, chocolate, occasionally, these flavors may be mixed with the yogurt and a granola blend.

According to an exemplary embodiment, the various spices and condiments that will be used for preparation of sweet and spicy flavors are as follows: cinnamon, black pepper, cardamom, red pepper, various varieties of chili peppers, coconut, cumin, nutmeg, cilantro, coriander, paprika, onion, thyme, turmeric, ginger, fennel, mustard, mint, cloves, tamarind, dates, habanero pepper, gourd, and/or squash, capsicum, chives, curry leaves, garlic, anise, asafoetida, (sometimes referred to as “Hing”), dill, varieties of salt, and any combination of the above. In an exemplary embodiment, these proposed flavors can be combined as follows: a tamarind chutney, a tamarind and date chutney, a plum chutney, a mint chutney, a spicy mango mix, a spicy gourd mix, a pomegranate chutney, and a spicy apple butter. For the purposes of sweetening such a yogurt mixture, various approved food ingredients, such as pure cane sugar, honey, corn sugar, jaggery, brown sugar, fruits, including without limitation, pear, coconut, orange, lemon, grapefruit, cranberries, grapes, raisins, and sultanas, fruit juices or fruit extracts, maple syrup, and fructose can be used according to one exemplary embodiment. Additionally, vegetables, such as potatoes, sweet potatoes, carrots, eggplant, ridged gourd, pumpkin, tomato, avocado, and cucumber can be incorporated. Further, nuts, such as peanuts, almonds, walnut, pistachio, and cashew nuts, can be added. Table 1 contrasts the flavors that are currently available in various marketed products with the proposed flavors.

TABLE 1
Currently available yogurt flavors vs. proposed flavors:

| Common Current Flavors | Proposed Flavors* |
|---|---|
| Plain | Tamarind Chutney |
| Banana | Tamarind and Date Chutney |
| Pineapple | Plum Chutney |
| Peach | Mint Chutney |
| Strawberry | Spicy Mango Mix |
| Raspberry | Spicy Gourd Mix |
| Blueberry | Pomegranate Chutney |
| Cherry | Spicy Apple Butter |
| Apple | |
| Mango | |
| Blackberry | |
| Vanilla | |
| Chocolate | |
| Coffee | |

*Other flavors can be derived from proposed ingredients

These flavors can be combined as follows in accordance with the following examples which are within the scope of the present inventive concept but are not intended to limit the scope of the present general inventive concept.

APPENDIX A:

Plum Chutney
1 Take ripe plums and cover with filtered water in a pan;
2 Heat on medium high heat and bring to a boil;
3 Add cardamom pods (1/plum) and cinnamon sticks;
4 When the peel of the plums comes off let the water cool;
5 Remove pits and mash the plums in the same water;
6 Bring to a boil again and add a selected volume of orange juice concentrate;
7 Boil until the chutney thickens;
8 Add sugar (1/2 Tsp/plum) and continue heating;
9 Add paprika, dried red pepper powder, dry mango powder, nutmeg, salt, black pepper;
10 Let the mixture cool; and
11 Pour chutney on plain yogurt, and mix.

Tamarind and Date Chutney
1. In a pan, take seedless tamarind, seedless dates, and add water;
2. Cook the tamarind and date for about 8-9 minutes on a low flame till they soften;
3. Add powdered jaggery and continue to cook;
4. Cook for another 8-9 minutes over a low flame;
5. Add red chili powder, dried habanero pepper, roasted cumin powder, dry ginger powder, nutmeg, tomato ketchup, pomegranate powder;
6. Bring the whole mixture to a boil;
7. Stir & simmer for a further 1-2 minutes more;
8. Season with salt;
9. Let the chutney mixture cool down;
10. Grind the whole mixture until smooth;
11. Add some water if required while grinding;
12. Strain through a strainer;
13. Store in an airtight container; and
14. Mix with plain yogurt.

Spicy Mango Mix
1 Take pure cane sugar and add white vinegar and filtered water over medium heat. Stir in mango puree and corn starch;
2 In another pan heat some vegetable oil, add paprika, nutmeg, dried habanero peppers, and pomegranate powder and stir for 2 to 3 minutes;
3 Add the mango puree to the spices and heat on low heat for 10 to 15 minutes;
4 Add orange juice concentrate, lemon juice concentrate and citric acid and stir;
5 Let the mixture cool;
6 Add xanthum gum to desired thickness; and
7 Mix with plain yogurt.

Further, in an exemplary embodiment, other ingredients can be incorporated, thickeners such as guar gum, xanthum gum, gum arabic, corn starch, and carrageenan can be added. And, if additional curdling of the yogurt is desired, vinegar can be added. In addition to the nuts described above, other protein sources can be added to the sweet and spicy yogurt mixtures. For instance, eggs, gelatin, cheese, khoya, legumes, such as lentils, peas, chick peas, and beans, and spicy ground meats such as chicken, beef, and bacon can add additional, flavor and texture. Those skilled in the art will recognize that various peppers have different flavor profiles; and that these flavor profiles are often covered up by the burning sensation produced by the capsaicin content of the pepper. It is believed that the dairy enzymes within the yogurt interact with the capsaicin of the peppers so as to mitigate the burning sensation of the peppers such that the flavor component of the peppers, for instance the habanero pepper, is enhanced allowing the individual consuming the yogurt mixture to have a greater appreciation of the flavor profiles of the various peppers admixed with the chutneys mixed with the yogurt. In this manner, the combination of the yogurt with the spicy ingredients enhances the underlying flavors of the spicy ingredients. It will be appreciated by those skilled in the art that in accordance with the present general inventive concept a chutney could be mixed with any selected fruit base and then mixed with the yogurt. Moreover, while a chutney is generally considered to be of Middle Eastern origin, specifically, Indian, other spicy vegetable/fruit mixtures, such as a salsa, could be mixed with yogurt in keeping with the present general inventive concept.

While the present invention has been illustrated by description of several embodiments, and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A bacterially fermented semi-solid dairy composition admixed with a spicy mixed food conglomerate, resulting in a spicy bacterially fermented semi-solid dairy composition, whereby dairy enzymes within said dairy composition interact to enhance a flavor profile of spices within the spicy food conglomerate, said spicy bacterially fermented semi-solid dairy composition comprising:
a selected amount of bacterially fermented semi-solid dairy composition;
at least one food product selected from a group consisting of fruits and vegetables;
at least one sweetener; and
at least one spicy component, whereby interaction between said dairy enzymes and said spices enhances the flavor profile of said spicy component, thereby increasing a consumer's enjoyment of said spicy bacterially fermented semi-solid dairy composition

2. The spicy bacterially fermented semi-solid dairy composition of claim 1 wherein said at least one food product selected from a group consisting of fruits and vegetables is further selected from a group consisting of banana, pineapple, peach, strawberry, raspberry, blueberry, cherry, apple, mango, blackberry, vanilla, chocolate, coffee beans, squash, gourd, mint, plum, pomegranate, apple, pear, coconut, orange, lemon, grapefruit, cranberries, grapes, raisins, sultanas, potatoes, sweet potatoes, carrots, eggplant, ridged gourd, pumpkin, tomato, avocado, cucumber, lentils, peas, chick peas, beans, and dates.

3. The spicy bacterially fermented semi-solid dairy composition of claim 1 wherein said at least one sweetener is selected from a group consisting of pure cane sugar, corn sugar, honey, jaggery, brown sugar, maple syrup, fructose, fruits, fruit juices, and fruit extracts.

4. The spicy bacterially fermented semi-solid dairy composition of claim 1 wherein said at least one spicy component is selected from a group consisting of cinnamon, black pepper, cardamom, red pepper, various varieties of chili peppers, coconut, cumin, nutmeg, cilantro, coriander, paprika, onion, thyme, turmeric, ginger, fennel, mustard, mint, cloves, tamarind, dates, capsicum, chives, curry leaves, garlic, anise, asafoetida, dill, and habanero pepper.

5. The spicy bacterially fermented semi-solid dairy composition of claim 1 wherein said spicy bacterially fermented semi-solid dairy composition further comprises a thickening agent selected from a group consisting of gelatin, guar gum, xanthum gum, gum arabic, corn starch, and carrageenan.

6. The spicy bacterially fermented semi-solid dairy composition of claim 1 wherein said spicy bacterially fermented semi-solid dairy composition further comprises an additional source of protein selected from a group consisting of peanuts, almonds, walnut, pistachio, cashew nuts, eggs, gelatin, cheese, khoya, legumes, lentils, peas, chick peas, beans, and ground chicken, ground beef, and ground bacon.

7. The spicy bacterially fermented semi-solid dairy composition of claim 1 wherein said spicy bacterially fermented semi-solid dairy composition is subjected to further curdling by the addition of vinegar.

8. A bacterially fermented semi-solid dairy composition admixed with a spicy mixed food conglomerate, resulting in a spicy bacterially fermented semi-solid dairy composition, whereby dairy enzymes within said dairy composition interact to enhance a flavor profile of spices within the spicy food conglomerate, said spicy bacterially fermented semi-solid dairy composition comprising:
a selected amount of bacterially fermented semi-solid dairy composition;
at least one food product selected from a group consisting of banana, pineapple, peach, strawberry, raspberry, blueberry, cherry, apple, mango, blackberry, vanilla, chocolate, coffee beans, squash, gourd, mint, plum, pomegranate, apple, pear, coconut, orange, lemon, grapefruit, cranberries, grapes, raisins, sultanas, potatoes, sweet potatoes, carrots, eggplant, ridged gourd, pumpkin, tomato, avocado, cucumber, lentils, peas, chick peas, beans, and dates;
at least one sweetener; and
at least one spicy component, whereby interaction between said dairy enzymes and said spices enhances the flavor profile of said spicy component, thereby increasing a consumer's enjoyment of said spicy bacterially fermented semi-solid dairy composition

9. The spicy bacterially fermented semi-solid dairy composition of claim 8 wherein said at least one sweetener is selected from a group consisting of pure cane sugar, corn sugar, honey, jaggery, brown sugar, maple syrup, fructose, fruits, fruit juices, and fruit extracts.

10. The spicy bacterially fermented semi-solid dairy composition of claim 8 wherein said at least one spicy component is selected from a group consisting of cinnamon, black pepper, cardamom, red pepper, various varieties of chili peppers, coconut, cumin, nutmeg, cilantro, coriander, paprika, onion, thyme, turmeric, ginger, fennel, mustard, mint, cloves, tamarind, dates, capsicum, chives, curry leaves, garlic, anise, asafoetida, dill, and habanero pepper.

11. The spicy bacterially fermented semi-solid dairy composition of claim 8 wherein said spicy bacterially fermented semi-solid dairy composition further comprises a thickening agent selected from a group consisting of gelatin, guar gum, xanthum gum, gum arabic, corn starch, and carrageenan.

12. The spicy bacterially fermented semi-solid dairy composition of claim 8 wherein said spicy bacterially fermented semi-solid dairy composition further comprises an additional source of protein selected from a group consisting of peanuts, almonds, walnut, pistachio, cashew nuts, eggs, gelatin, cheese, khoya, legumes, lentils, peas, chick peas, beans, and ground chicken, ground beef, and ground bacon.

13. A bacterially fermented semi-solid dairy composition admixed with a spicy mixed food conglomerate, resulting in a spicy bacterially fermented semi-solid dairy composition, whereby dairy enzymes within said dairy composition interact to enhance a flavor profile of spices within the spicy food conglomerate, said spicy bacterially fermented semi-solid dairy composition comprising:
a selected amount of bacterially fermented semi-solid dairy composition;
at least one food product selected from a group consisting of fruits and vegetables;
at least one sweetener; and
at least one spicy component selected from a group consisting of cinnamon, black pepper, cardamom, red pepper, various varieties of chili peppers, coconut, cumin, nutmeg, cilantro, coriander, paprika, onion, thyme, turmeric, ginger, fennel, mustard, mint, cloves, tamarind, dates, capsicum, chives, curry leaves, garlic, anise, asafoetida, dill, and habanero pepper, whereby interaction between said dairy enzymes and said spices enhances the flavor profile of said spicy component, thereby increasing a consumer's enjoyment of said spicy bacterially fermented semi-solid dairy composition

14. The spicy bacterially fermented semi-solid dairy composition of claim 13 wherein said at least one food product selected from a group consisting of fruits and vegetables is further selected from a group consisting of banana, pineapple, peach, strawberry, raspberry, blueberry, cherry, apple, mango, blackberry, vanilla, chocolate, coffee beans, squash, gourd, mint, plum, pomegranate, apple, pear, coconut, orange, lemon, grapefruit, cranberries, grapes, raisins, sultanas, potatoes, sweet potatoes, carrots, eggplant, ridged gourd, pumpkin, tomato, avocado, cucumber, lentils, peas, chick peas, beans, and dates.

15. The spicy bacterially fermented semi-solid dairy composition of claim 14 wherein said at least one sweetener is selected from a group consisting of pure cane sugar, corn sugar, honey, jaggery, brown sugar, maple syrup, fructose, fruits, fruit juices, and fruit extracts.

16. The spicy bacterially fermented semi-solid dairy composition of claim 15 wherein said spicy bacterially fermented semi-solid dairy composition further comprises an additional source of protein selected from a group consisting of peanuts, almonds, walnut, pistachio, cashew nuts, eggs, gelatin, cheese, khoya, legumes, lentils, peas, chick peas, beans, and ground chicken, ground beef, and ground bacon.

17. The spicy bacterially fermented semi-solid dairy composition of claim 16 wherein said spicy bacterially fermented semi-solid dairy composition further comprises a thickening agent selected from a group consisting of gelatin, guar gum, xanthum gum, gum arabic, corn starch, and carrageenan.

18. The spicy bacterially fermented semi-solid dairy composition of claim 17 wherein said spicy bacterially fermented semi-solid dairy composition is subjected to further curdling by the addition of vinegar.
